(19) United States
(12) Patent Application Publication
(10) Pub. No.: US 2004/0161576 A1
(43) Pub. Date: Aug. 19, 2004

(54) Method of manufacturing master disc for magnetic transfer, a master disc thereof, and a master disc formed thereby

(76) Inventor: Hiroyuki Yoshimura, Tokyo (JP)

Correspondence Address: ROSSI & ASSOCIATES, P.O. Box 826, Ashburn, VA, 20146-0826, US

(21) Appl. No.: 10/658,687

(22) Filed: Sep. 9, 2003

(30) Foreign Application Priority Data
Feb. 14, 2003 (JP) 2003-037308

(51) Int. Cl. B32B 3/02

(52) U.S. Cl. 428/65.3; 428/694 ST

(57) ABSTRACT

A master disc has a magnetic pattern of magnetic thin film having a sufficient thickness in the grooves formed on the surface of an Si substrate for magnetically transferring the magnetic pattern thereof to a magnetic recording medium with reduced or minimized sub pulses. A SiO₂ film is formed on the Si substrate, and the SiO₂ film is used as a mask to form grooves (magnetic pattern) on the surface of the substrate. When a soft magnetic thin film formed on the patterned surface of the Si substrate is polished off by a CMP technique so that a magnetic pattern of the magnetic thin film is left only in the grooves, the SiO₂ film acts as a polishing stopper to prevent erosion of the groove thickness during the CMP polishing.

### BACKGROUND

Presently, a master disc is used for magnetically transferring data, namely used when a servo signal for positioning a writing/reading head for data written on the surface of a magnetic recording disc or specific data are written using a magnetic transfer technique in a hard disc drive (hereinafter abbreviated to HDD), which is mainly used as an external storage device.

In HDDs, data are recorded/reproduced while a magnetic head is floated above the surface of a rotating magnetic recording medium spaced apart from the surface of the disc with a small gap of several tens nm by a floating mechanism (slider). Bit information on the magnetic recording medium is stored in the data tracks arranged concentrically on the medium, and the data recording/reproducing head is moved/positioned to a target data track on the surface of the medium at a high speed to perform the data recording/reproduction. A positioning signal (servo signal) for detecting the relative position between the head and each data track is concentrically written on the surface of the magnetic recording medium, and the head carrying out the data recording/reproduction detects the position thereof at a fixed time interval. The magnetic recording mediums is installed in the HDD device so that the center of the writing signal of the servo signal is not deviated from the center of the medium (or the center of the locus of the head), and then the servo signal is written by using a dedicated device called as a servo writer.

At the present developing stage, the recording density of the HDD device has reached 100 Gbits/in², and the storage capacity thereof is increased about 60% per year. In connection with this, there is a tendency for the density of the servo signal with which the head detects the position thereof to be also increased, while the writing time of the servo signal is increased year by year. The increase of the writing time of the servo signal is a significant factor that reduces productivity of HDD and increases the cost thereof.

As compared with the servo signal writing system using the signal writing head of the servo writer described above, a technique for collectively writing a servo signal through magnetic transfer to dramatically shorten the writing time of servo information has been developed recently. FIGS. 2A-2C and 3A-3B schematically show this magnetic transfer technique.

FIG. 3A shows a cross-sectional view of a substrate with a permanent magnet 2 moving on the surface of a magnetic recording medium 1. The magnet 2 is kept spaced at a fixed interval (1 mm or less). A magnetic film 1b formed on the substrate 1a (constituting the magnetic recording medium 1) is initially not magnetized in a uniform direction, but is magnetized in a uniform direction by the magnetic field leaking from the gap of the permanent magnet 2 (arrows 1c represent the direction of the magnetization). This step is called an initial demagnetizing step.

The arrow illustrated in FIG. 2A represents a movement path of the permanent magnet so that the magnetic layer is uniformly magnetized in the circumferential direction. FIG. 2B shows a state where a magnetic transfer master disc 3 (hereinafter “master disc”) is arranged above the magnetic recording medium 1. FIG. 2C shows the state in which magnetic transfer is carried out by bringing the master disc 3 into close contact with the surface of the magnetic recording medium 1 while moving the permanent magnet for magnetic transfer along the movement path (indicated by an arrow).

FIG. 3B shows the magnetic transfer technique. Here, the master disc 3 has a soft magnetic film 3b (Co type soft magnetic film) embedded at a surface side, which is brought into contact with the medium surface of the silicon substrate 1. When the substrate (master disc) having a pattern of the soft magnetic film 3b embedded therein is interposed between the permanent magnet 2 and the magnetic recording medium 1 as illustrated, the magnetic field leaking from the permanent magnet 2 and infiltrating into the substrate 1 (the direction of magnetic field for transfer signal writing is opposite to the direction of magnetic field for demagnetization) can be transmitted through the substrate 1 to magnetize the magnetic layer 1b at the portions where no soft magnetic film 3b is provided (the direction of this magnetic field is represented by 1d). However, at the portions where the pattern of the soft magnetic layer 3b exists, the magnetic field is transmitted through the soft magnetic film 3b to form a magnetic path having small magnetic resistance. Therefore, at the positions where the soft magnetic layer exists, the magnetic field leaking from the silicon substrate 1 is reduced, and new magnetization writing is not carried out. According to the above mechanism, the servo signal is magnetically transferred.

FIGS. 4A-4E show the process of manufacturing the master disc. In the first step, a resist film 4 (1.2 μm in thickness) is coated on the surface of a silicon substrate 3a (500 μm thick) by using a spin coater, and then the resist film 4 is subjected to patterning by using photolithography as in the case of a normal silicon-semiconductor manufacturing method. The resist film is used as a mask for etching in a second step. The resist film is formed of novolak-based material, and thus it is not resistant to etching. Therefore, it is important for the resist film to be thick to the extent that the etching is distinguished by the etching steps illustrated in FIGS. 4A and 4B.

In the second step, the silicon is dry-etched 500 nm by using a reactive plasma etching method (reactive gas: methane trichloride) to form grooves 5 (see FIG. 4C). In the third step, a soft magnetic film 3b (500 nm thick or otherwise to completely fill the grooves) is formed by sputtering over the resist film 4. The soft magnetic film 3b becomes embedded in the grooves 5, as illustrated in FIG. 4D. In the fourth step, after the soft magnetic film 3b is formed, the silicon substrate 3a is immersed in a solvent to dissolve and remove the resist film 4 (while using ultrasonic wave or the like as occasion demands) remaining between the soft magnetic film 3b and the silicon substrate 3a. See FIG. 4E.

FIGS. 6A-6G show cross-sectional shapes (micrographs) of the etched grooves 5 having respective sizes in which the soft magnetic film 3b is embedded. In the fourth step, a remover, which is formed of a strong alkali solution or the like, dissolves the resist film and invades through the gap formed between the side surface of each groove and the soft magnetic film 3b attached to the side surface of the groove, infiltrates into the interface between the silicon substrate 3a and the resist film 4 and dissolves the resist film 4. However, the pattern width of the magnetic film is set to 0.5 μm or less in the master disc for high recording density, so that the magnetic film hardly reaches the bottom of the grooves formed in the Si substrate. Therefore, it is necessary to deposit the film by carrying out sputtering for a long time until a desired thickness is achieved. Therefore, as the film thickness of the soft magnetic film attached to the side surfaces of the recess portions is increased, and the infiltration of the remover in the fourth step is lowered, the resist film cannot be sufficiently exfoliated.

FIGS. 7A and 7B (micrographs) show surface observation images subjected to lift-off in the fourth step. FIG. 7A is a cross-sectional view and FIG. 7B is a plan view. These images illustrate burrs 3c formed in the soft magnetic film 3b, attached to the side surfaces of the recess portions. When the burrs 3c are formed, the adhesion between the master disc and the magnetic recording medium in the magnetic transfer operation is lowered. In this respect, JP-A2001-34938 discloses polishing and removing the burrs with polishing liquid (Conpole 80, which contains resin of amine dispersed with colloidal silica and alumina particles). A CMP (Chemical Mechanical Polishing) method comes to known as the polishing method for removing the soft magnetic film. See JP-A-11-339242, for example.

According to the polishing method using the polishing liquid containing resin type amine dispersed with colloidal silica or alumina particles, the polishing amount is proportional to the polishing time. But burrs are also polished at the surface of the Si substrate where no burrs exist. Consequently, the depth of the grooves in which the soft magnetic film is embedded is reduced at the portion where no burr exists. When CMP is applied, the same happens.

Dispersion occurs in the amount of burrs among substrates. Therefore, to surely remove the burrs, it is necessary to increase the thickness to be polished. In the magnetic transfer operation, the magnetic flux caused by the transfer magnetic field passes through the soft magnetic film embedded in the recess portions, but does not pass through the magnetic recording medium side to transfer the magnetic pattern. If the thickness of the soft magnetic film is reduced to a value less than a desired thickness by polishing, the magnetic flux density in the soft magnetic film exceeds the saturated magnetic flux density of the soft magnetic material, and the magnetic flux leaks to the magnetic recording medium side. By the leakage of the magnetic flux to the magnetic recording medium, sub pulses as shown in FIGS. 5A and 5B (indicated by arrows in the figure) are generated in the magnetic reproduction signal from a magnetic recording medium subjected to the magnetic transfer. This can generate an erroneous signal. FIG. 5A shows the normal reproduction signal. To prevent this problem, the depth of the recess portions can be increased, and the thickness of the soft magnetic film can be set larger. However, when the groove width is not more than 0.5 μm, it is difficult to sufficiently embed the magnetic film in the recess portions if the recess portions are deeper.

Accordingly, there remains a need for a master disc for magnetic transfer that solves the above problems. The present invention addresses this need.

### SUMMARY OF THE INVENTION

The present invention relates to a method of manufacturing a master disc for magnetic transfer, a master disc thereof, and a master disc formed thereby.

One aspect of the present invention resides in a method of manufacturing a master disc for a magnetic disc. The method involves providing a substrate, forming an SiO₂ film on the surface of the substrate, etching the SiO₂ film to form a magnetic pattern on the surface of the substrate, etching the substrate using the SiO₂ film as a mask to form grooves corresponding to the magnetic pattern, forming a magnetic film on the surface of the substrate to fill the grooves and cover the SiO₂ film, and polishing the soft magnetic film to expose the surface of the SiO₂ film. The SiO₂ film acts as a polishing stopper.

The substrate can be a silicon substrate. The method can further include forming a photoresist film on the SiO₂ film, patterning the photoresist film, and developing the photoresist film to form a photoresist mask to etch the SiO₂ film to form the magnetic pattern. The SiO₂ film can be etched under a mixed gas atmosphere containing CHF₃ and oxygen using the photoresist as a mask. The substrate can be etched under an SF₆ gas atmosphere to form the grooves having a depth of about 0.5 μm. The magnetic film of about 1 μm can be deposited on the substrate by sputtering to fill the grooves and cover the SiO₂ film. The SiO₂ film can have a thickness ranging 0.1 to 0.2 μm is formed on the surface of the substrate by thermal oxidation. Each of the grooves can have a width not greater than about 0.5 μm.

Another aspect of the present invention is the product formed by the above method, namely a master disc.

Another aspect of the present invention is a master disc for a magnetic disc. The master disc has a substrate having grooves corresponding to a magnetic pattern, an SiO₂ film on the surface of the substrate, the SiO₂ film having channels corresponding to the magnetic pattern and aligned with the grooves of the substrate, and a magnetic material filling the grooves and the channels. The substrate can be a silicon substrate. Each of the grooves can be about 0.5 μm deep. Each of the grooves and the channels can be not greater than about 0.5 μm wide. The SiO₂ film can have a thickness ranging 0.1 to 0.2 μm.

### BRIEF DESCRIPTION OF THE DRAWINGS

FIGS. 1A-1H are diagrams showing the process of manufacturing a master disc according to this invention.

FIGS. 2A-2C are diagrams showing a magnetic transfer process for a magnetic recording medium.

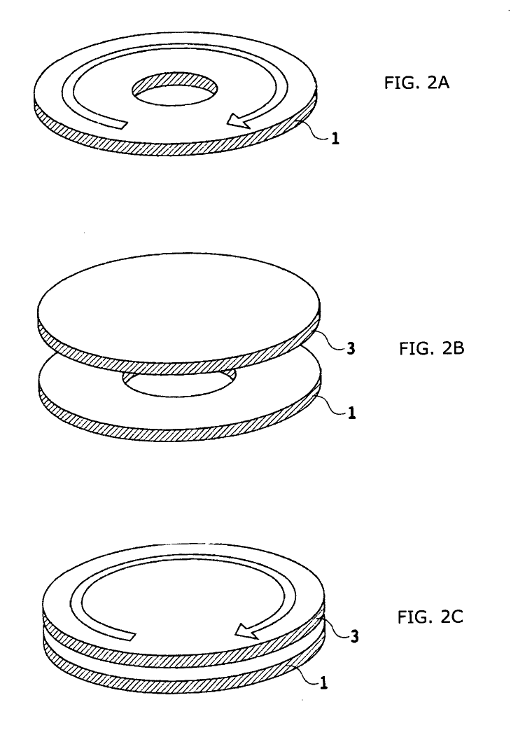

FIGS. 3A and 3B are diagrams showing the principle of the magnetic transfer for the magnetic recording medium.

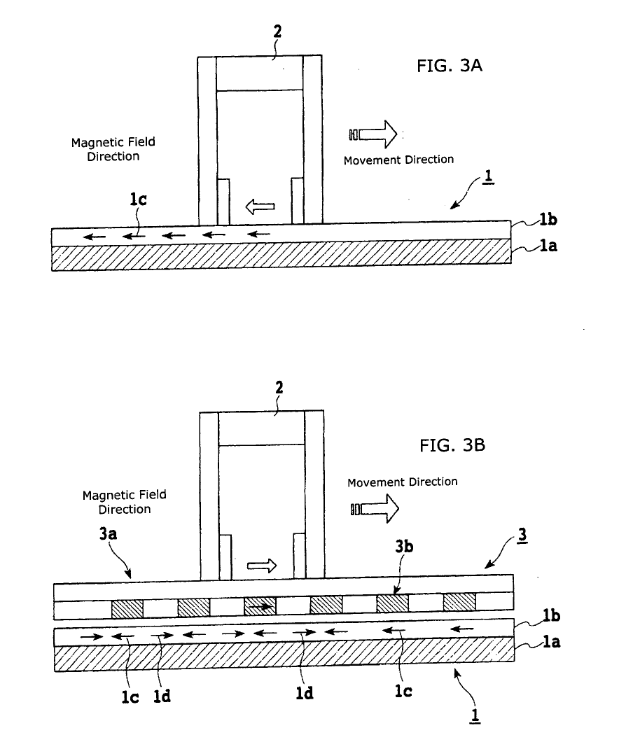

FIGS. 4A-4E are diagrams showing the process of manufacturing a master disc.

FIGS. 5A-5C are diagrams showing reproduction signals achieved from a magnetic recording medium on which a magnetic pattern is formed by magnetic transfer.

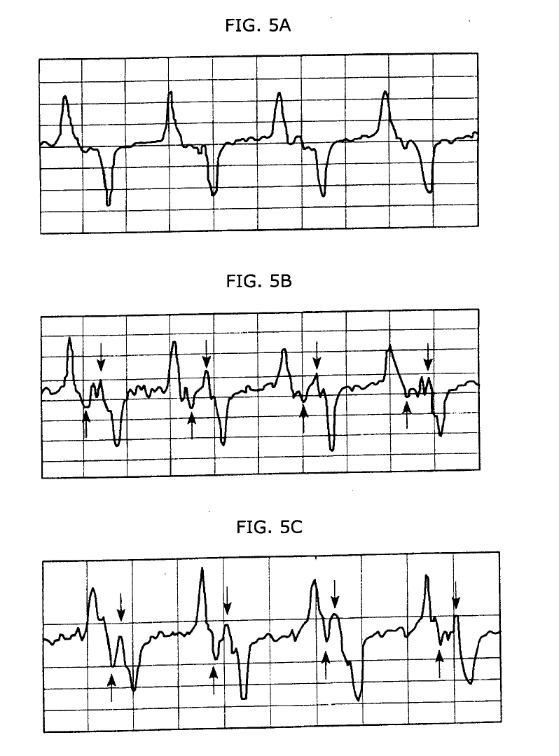

FIGS. 6A-6G are cross-sectional views showing embedding of soft magnetic film in grooves by etching.

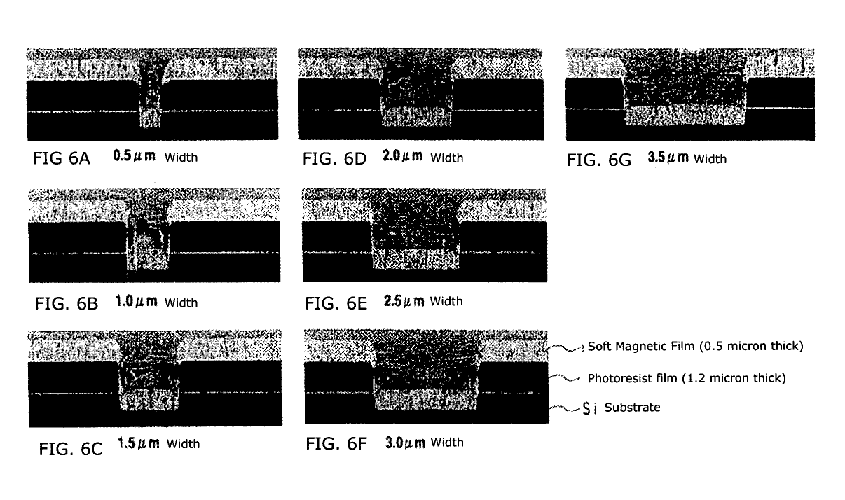

FIGS. 7A and 7B are surface observation image diagrams showing a state of burr of the soft magnetic film in the master disc.

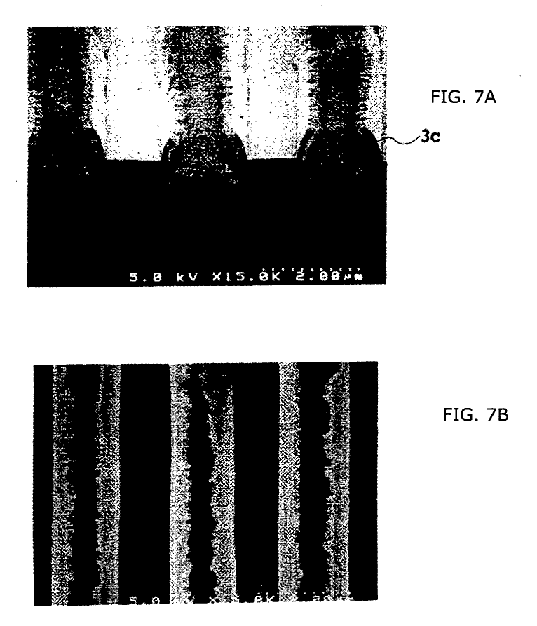

### DETAILED DESCRIPTION

The present method includes forming a SiO₂ film to a thickness of 0.1 to 0.2 μm on the surface of an Si substrate by a thermal oxidation treatment. A photoresist film is coated on the SiO₂ film, patterned, and developed after patterning to form a photoresist mask for etching the SiO₂ film. The SiO₂ film can be etched under a mixed gas atmosphere containing CHF₃ and oxygen using the photoresist as a mask. Etching is stopped when the surface of the Si substrate is exposed. The thus formed SiO₂ film is then used as a mask for etching the Si substrate. The Si can be etched under an SF₆ gas atmosphere to form recess portions or grooves having a depth of 0.5 μm. A soft magnetic film of about 1 μm can be deposited on the Si substrate by a sputtering technique, filling the recess portions.

The hardness of the SiO₂ film formed on the surface of the Si substrate is ten times greater than that of Si. A CMP (Chemical Mechanical Polishing) method, which uses polishing liquid that includes a mixture of fine powder of alumina, silica, ceria, and oxidized manganese, with additive that oxidizes polishing target material, is used to polish off the magnetic film. As the hardness of SiO₂ is about ten times or greater than the hardness of Si, which is the substrate material of the master disc, the SiO₂ can be polished without affecting the depth of the grooves.

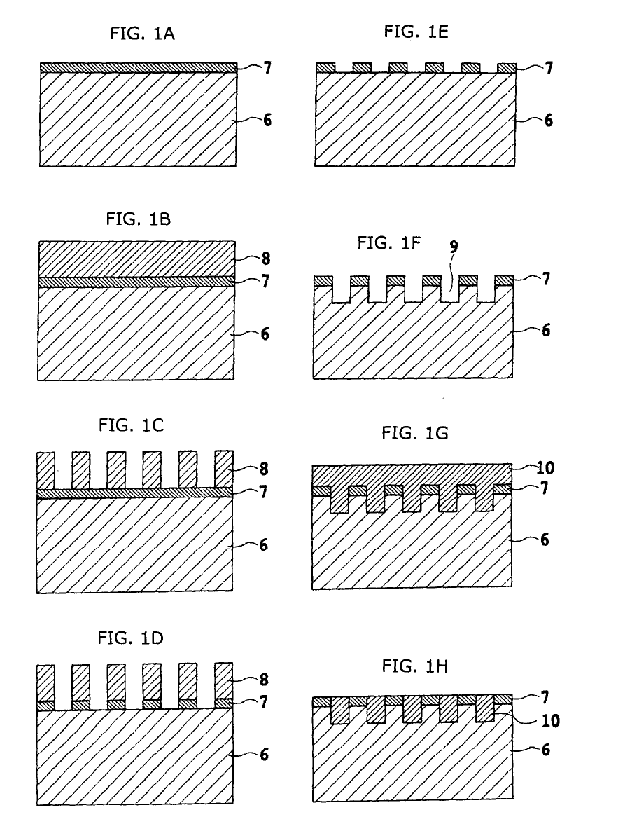

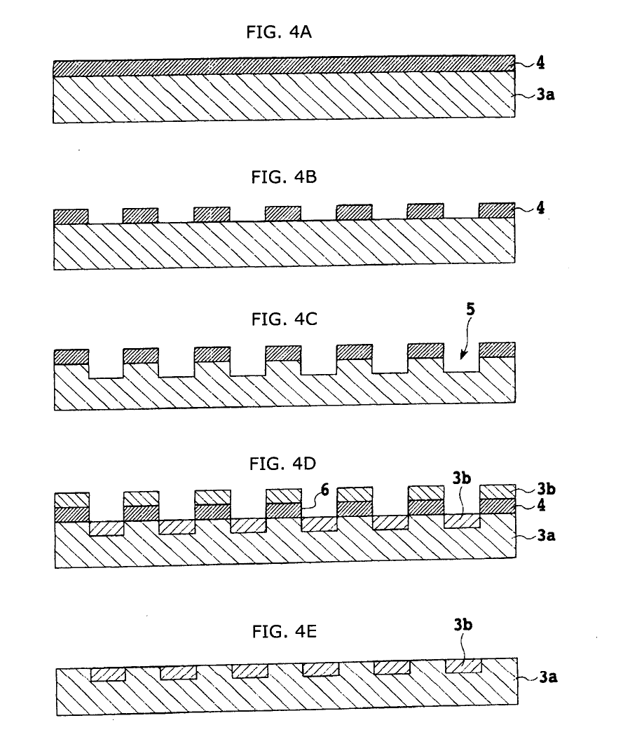

FIG. 1 shows the manufacturing process of a master disc according to this invention. The present method differs from the method illustrated in FIGS. 4A-4E in that the present method uses a mask formed of an SiO₂ film. After etching the SiO₂ film to form channels corresponding to the magnetic pattern to expose a corresponding pattern on the surface of the substrate, the remaining SiO₂ film is deliberately left on the substrate. The reason why SiO₂ film is used as the mask is as follows. The etching rate in the process of forming the grooves is equal to 1:3 for the resist and Si, whereas the etching rate is equal to 1:20 for SiO₂ and Si. Moreover, the thickness of the mask when the Si substrate is etched to form the grooves having the same depth is equal to 1.2 μm in the case of the conventional resist, whereas, the thickness in the case of the SiO₂ film is much thinner, namely 0.2 μm thick. Accordingly, when the soft magnetic film is formed in the grooves of 0.5 μm deep and 0.5 μm wide formed in the Si substrate, for example, the total depth (the depth of the channels of the SiO₂ film plus the depth of the grooves) is only 0.7 μm, and the aspect ratio is only 1.4 in the case of the SiO₂ mask, whereas the groove depth is 1.7 μm and the aspect ratio is 3.4 in the case of the conventional photoresist mask. Thus, the soft magnetic film can be more easily embedded in the recess portions in the case of the SiO₂ mask. Therefore, the manufacturing method using the SiO₂ mask according to the present invention is more beneficial for manufacturing a mask disc for high recording density.

Referring to FIGS. 1A-1H, a master disc can be manufactured according to the following steps. On a silicon substrate 6, an SiO₂ film 7 of 0.2 μm thick is formed by thermally oxiding the surface of the silicon substrate 6 (FIG. 1A). Thereafter, a photoresist film 8 of 0.2 μm thick can be coated on the SiO₂ film 7 (FIG. 1B). The etching rate of an oxide film etching device can be set to 1:2. Thus, a photoresist film thickness of about 0.2 μm is sufficient to etch the 0.2 μm thick SiO₂ film. After forming the photoresist film 8, it is patterned corresponding to the desired magnetic pattern, for example, by an electron beam exposure device, so that the photoresist film 8 is exposed to light. The photoresist film 8 is developed, for instance, by immersing the substrate 6 in a developing solution to remove the light-exposed portions of the photoresist film 8(FIG. 1C).

Using the developed photoresist film 8 as a mask, the exposed SiO₂ film 7 can be etched under a mixed gas atmosphere containing CHF₃ and oxygen, just as using an oxide film etching device. The etching progress is stopped when the Si surface is exposed, so that the pattern formed on the photoresist film 8 is transferred to the SiO₂ film 7 (FIG. 1D). Since the photoresist film 8 is unnecessary, it is removed by heating (ashed) so that only the unetched portions of the SiO₂ film 7 are left (FIG. 1E). Using the remaining portions of the SiO₂ film 7 as a mask, the exposed surface of the substrate is etched under an SF₆ gas atmosphere, for instance, with an Si etching device, to form the grooves 9 to a predetermined depth (FIG. 1F). A soft magnetic film 10 can be deposited on the substrate 6 by sputtering, for instance, with a sputtering device having excellent direct advance performance (FIG. 1G). The soft magnetic film 10 protruding beyond the depth of the grooves 9 (surface of the SiO₂ film) is polished off with a CMP technique until the upper surface of the SiO₂ film is exposed (FIG. 1H).

During the CMP polishing step, the polishing rate of the SiO₂ film 7 and the polishing rate of the magnetic film of Co or the like can be set in advance since the thickness of the soft magnetic film 10 deposited on the SiO₂ film 7 is known. Accordingly, the CMP polishing time can be estimated. Nonetheless, the actual polishing time can allot extra time to the estimated polishing time to ensure that the soft magnetic film 10 is completely removed from the upper surface of the SiO₂ film 7. The soft magnetic film deposited on the SiO₂ film 7 is polished at the initial rate of polishing. When the upper surface of the SiO₂ film 7 is reached, the polishing rate can be reduced so that only a slight amount of the SiO₂ film 7 is polished.

When the polishing based on CMP is applied to the manufacturing of a master disc having a pattern of 31 m wide, it has been observed that polishing substantially to the surface of the SiO₂ film 7 recesses the soft magnetic portion by about 0.06 μm with respect to the surface of the SiO₂ film 7 because the polishing rate of the SiO₂ film is considerably lower than that of the soft magnetic film of Co. By narrowing the width of the servo pattern approximately to the current width of 0.2 μm, however, the recess of the soft magnetic film can be greatly reduced. Thus, the reduction in transfer performance of the magnetic transfer can be avoided.

As described above, the surface position of the master disc on which the polishing treatment is carried out can be stably set to the surface of the SiO₂ film formed on the Si substrate. Therefore, dispersion in the thickness of the soft magnetic film embedded in the recess portions of the silicon substrate can be reduced. Therefore, the master disc manufactured according to the present invention can prevent or reduce sub pulses in the reproduction signal achieved from the magnetic recording medium after the magnetic transfer so that the magnetic transfer performance based on the master disc can be stabilized.

Given the disclosure of the present invention, one versed in the art would appreciate that there may be other embodiments and modifications within the scope and spirit of the present invention. Accordingly, all modifications and equivalents attainable by one versed in the art from the present disclosure within the scope and spirit of the present invention are to be included as further embodiments of the present invention. The scope of the present invention accordingly is to be defined as set forth in the appended claims.

The disclosure of the priority application, JP 2003-037308, in its entirety, including the drawings, claims, and the specification thereof, is incorporated herein by reference.

What is claimed is:

1. A method of manufacturing a master disc for a magnetic disc, comprising the steps of:
providing a substrate;
forming an SiO₂ film on the surface of the substrate;
etching the SiO₂ film to form a magnetic pattern on the surface of the substrate;
etching the substrate using the SiO₂ film as a mask to form grooves corresponding to the magnetic pattern;
forming a magnetic film on the surface of the substrate to fill the grooves and cover the SiO₂ film; and
polishing the soft magnetic film to expose the surface of the SiO₂ film, wherein the SiO₂ film acts as a polishing stopper.

2. A method according to claim 1, wherein the substrate is a silicon substrate.

3. A method according to claim 2, further including the steps of forming a photoresist film on the SiO₂ film, patterning the photoresist film, and developing the photoresist film to form a photoresist mask for etching the SiO₂ film.

4. A method according to claim 3, wherein the SiO₂ film is etched under a mixed gas atmosphere containing CHF₃ and oxygen using the photoresist as a mask.

5. A method according to claim 4, wherein the substrate is etched under an SF₆ gas atmosphere to form the grooves having a depth of about 0.5 μm.

6. A method according to claim 5, wherein the magnetic film of about 1 μm is deposited on the substrate by sputtering to fill the grooves and cover the SiO₂ film.

7. A method according to claim 6, wherein the SiO₂ film having a thickness ranging 0.1 to 0.2 μm is formed on the surface of the substrate by thermal oxidation.

8. A method according to claim 1, wherein each of the grooves has a width not greater than about 0.5 μm.

9. A master disc formed according to the method of claim 1.

10. A master disc for a magnetic disc, comprising:
a substrate having grooves corresponding to a magnetic pattern;
an SiO₂ film on the surface of the substrate, the SiO₂ film having channels corresponding to the magnetic pattern and aligned with the grooves of the substrate; and
a magnetic material filling the grooves and the channels.

11. A master disc according to claim 10, wherein the substrate is a silicon substrate.

12. A master disc according to claim 10, wherein each of the grooves is about 0.5 μm deep.

13. A master disc according to claim 10, wherein the SiO₂ film has a thickness ranging 0.1 to 0.21 μm.

14. A master disc according to claim 10, wherein each of the grooves has a width not greater than about 0.5 μm.
